(19) United States
(12) Patent Application Publication
(10) Pub. No.: US 2025/0279802 A1
(43) Pub. Date: Sep. 4, 2025

(54) Method and Apparatus for Adjusting Harmonic Parameter, Processor and Electronic Device

(71) Applicants: Analogix (Suzhou) Semiconductor Co., LTD., Suzhou, Jiangsu (CN); ANALOGIX INTERNATIONAL LLC, Delaware, DE (US)

(72) Inventor: Chuncheng GUO, Suzhou, Jiangsu (CN)

(21) Appl. No.: 18/029,099

(22) PCT Filed: Feb. 14, 2023
(86) PCT No.: PCT/CN2023/075991

§ 371 Date: Mar. 29, 2023

(30) Foreign Application Priority Data
Nov. 24, 2022 (CN) 202211483096.2

(51) Int. Cl. H04B 1/525; H04B 1/69

(52) U.S. Cl. CPC H04B 1/525; H04B 1/69

(57) ABSTRACT

The present disclosure provides a method and apparatus for adjusting a harmonic parameter, a processor and an electronic device. The method includes: a target signal is determined, and the target signal is a communication signal by means of which a processor of a device interacts with other devices at present; a plurality of harmonics corresponding to a plurality of chips are determined, and whether a target harmonic present in the plurality of the harmonics is determined, and the target harmonic is a harmonic interfering with the target signal, and the plurality of the chips exist in the device; and in a case that the target harmonic is present, the harmonic parameter of the target harmonic is adjusted to a target harmonic parameter.

### CROSS-REFERENCE TO RELATED APPLICATION

The present disclosure claims the priority of a patent file, having an Application November 202211483096.2, filed in on Nov. 24, 2022, and entitled “Method and Apparatus for Adjusting Harmonic Parameter, Processor and Electronic Device”, and the entire contents of which are herein incorporated by reference.

### TECHNICAL FIELD

The present disclosure relates to the field of communications, and in particular, to a method and apparatus for adjusting a harmonic parameter, a processor and an electronic device.

### BACKGROUND

With the development of the wireless communication technology, more and more frequency bands are used, such as WiFi, 4G, 5G, and the like. In actual system applications, in addition to conventional wireless communication chips, a large number of chips generate EMI (electromagnetic radiation interference) during operation and communication, thereby affecting normal wireless communication functions.

A common method for inhibiting the electromagnetic radiation interference is to cover by means of an electromagnetic shielding material, but the cost of the electromagnetic material is high, and meanwhile, a special mold design is required, therefore the production processes are increased.

Therefore, in view of the above problems, no effective solution is proposed yet.

### SUMMARY

According to one aspect of the embodiments of the present disclosure, provided is a method for adjusting a harmonic parameter, the method includes: a target signal is determined, and the target signal is a communication signal by means of which a processor of a device interacts with other devices at present; a plurality of harmonics corresponding to a plurality of chips are determined, and whether a target harmonic present in the plurality of the harmonics is determined, and the target harmonic is a harmonic interfering with the target signal, and the plurality of the chips exist in the device; and in a case that the target harmonic is present, the harmonic parameter of the target harmonic is adjusted to a target harmonic parameter.

Optionally, the plurality of the harmonics corresponding to the plurality of the chips are determined, and whether the target harmonic present in the plurality of the harmonics is determined, includes: a plurality of harmonic frequency bands corresponding to the plurality of the harmonics are determined; a plurality of frequency band differences between the plurality of the harmonic frequency bands and a target frequency band are calculated respectively, and a plurality of frequency band difference absolute values corresponding to the plurality of the frequency band differences are determined, and the target frequency band is a communication frequency band corresponding to the target signal, one frequency band difference corresponds to one frequency band difference absolute value, and the frequency band difference absolute value is an absolute value of the frequency band difference; and whether the target harmonic present in the plurality of the harmonics is determined according to the plurality of the frequency band difference absolute values.

Optionally, whether the target harmonic present in the plurality of the harmonics is determined according to the plurality of the frequency band difference absolute values, includes: whether a target frequency band difference absolute value present in the plurality of the frequency band difference absolute values is determined, and the target frequency band difference absolute value is a frequency band difference absolute value within a preset frequency band range; and in a case that the target frequency band difference absolute value is present, the harmonic corresponding to the target frequency band difference absolute value is determined as the target harmonic.

Optionally, the plurality of the harmonics corresponding to the plurality of the chips are determined, and whether the target harmonic present in the plurality of the harmonics is determined, includes: a target running clock of the processor is determined; a plurality of harmonic clocks corresponding to the plurality of the harmonics are determined, and one harmonic corresponds to one harmonic clock, and the harmonic clock is a clock of the corresponding harmonic; and whether the target harmonic present in the plurality of the harmonics is determined according to the target running clock and the plurality of the harmonic clocks.

Optionally, whether the target harmonic present in the plurality of the harmonics is determined according to the target running clock and the plurality of the harmonic clocks, includes: whether a harmonic clock affecting the target running clock present in the plurality of the harmonic clocks is determined; and in a case that one or more the harmonic clocks affecting the target running clock are present in the plurality of the harmonic clocks, the harmonic corresponding to the harmonic clock is determined as the target harmonic.

Optionally, after the target signal is determined, the method further includes: the target signal is broadcast to the plurality of the chips and a timing controller corresponding to the device.

Optionally, in the case that the target harmonic is present, the harmonic parameter of the target harmonic is adjusted to the target harmonic parameter, includes: the clock of target chip is adjusted to a target clock, and under the target clock, the target harmonic does not affect the communication signal, and the target chip is a chip that emits the target harmonic; or, the spread spectrum of the target harmonic is adjusted to a target spread spectrum, and the target spread spectrum disperses energy corresponding to the target harmonic within a preset range; or, the clock of the target chip is adjusted to the target clock, and the spread spectrum of the target harmonic is adjusted to the target spread spectrum.

According to another aspect of the embodiments of the present disclosure, further provided is an apparatus for adjusting a harmonic parameter, the apparatus includes: a first determination component, configured to determine a target signal, and the target signal is a communication signal by means of which a processor of a device interacts with other devices at present; a second determination component, configured to determine a plurality of harmonics corresponding to a plurality of chips, and determine whether a target harmonic is present in the plurality of the harmonics, and the target harmonic is a harmonic interfering with the target signal, and the plurality of the chips exist in the device; and an adjustment component, configured to, in a case that the target harmonic is present, adjust the harmonic parameter of the target harmonic to a target harmonic parameter.

According to another aspect of the embodiments of the present disclosure, further provided is a computer-readable storage medium. The computer-readable storage medium includes a stored program, and the program executes a method for adjusting a harmonic parameter.

According to another aspect of the embodiments of the present disclosure, further provided is a processor. The processor is configured to run a program, and the program executes a method for adjusting a harmonic parameter while running.

According to another aspect of the embodiments of the present disclosure, further provided is an electronic device, including: one or more processors, a memory, and one or more programs, and the one or more programs are stored in the memory and are configured to be executed by the one or more processors, and the one or more programs are configured to execute a method for adjusting a harmonic parameter.

### BRIEF DESCRIPTION OF THE DRAWINGS

The drawings, which constitute a part of the present disclosure, are used for providing a further understanding of the present disclosure, and illustrative embodiments of the present disclosure and descriptions thereof are used for explaining the present disclosure, and do not constitute improper limitations to the present disclosure. In the drawings:

FIG. 1 is a flowchart of a method for adjusting a harmonic parameter provided according to an embodiment of the present disclosure;

FIG. 2 shows a flowchart of a method for determining interference harmonics provided by the present disclosure; and

FIG. 3 is a schematic diagram of an apparatus for adjusting a harmonic parameter provided according to an embodiment of the present disclosure.

### DETAILED DESCRIPTION OF THE EMBODIMENTS

It should be noted that, in the case of no conflict, embodiments in the present disclosure and features in the embodiments may be combined with each other. Hereinafter, the present disclosure will be described in detail with reference to the drawings and in conjunction with the embodiments.

In order that those skilled in the art may better understand the solutions of the present disclosure, a clear and complete description of technical solutions in the embodiments of the present disclosure will be given below, in combination with the drawings in the embodiments of the present disclosure. Apparently, the embodiments described below are merely a part, but not all, of the embodiments of the present disclosure. All of other embodiments, obtained by those ordinary skilled in the art based on the embodiments in the present disclosure without any creative effort, should fall into the protection scope of the present disclosure.

It should be noted that, the terms “first” and “second” and the like in the specification and claims of the present disclosure and the above-mentioned drawings are used for distinguishing similar objects, and are not necessarily used for describing a specific sequence or a precedence order. It should be understood that the data used in this way may be interchanged under appropriate circumstances, so as to describe the embodiments of the present disclosure herein. Furthermore, the terms “including” and “having”, and any variations thereof are intended to cover non-exclusive inclusions, for example, processes, methods, systems, products or devices including a series of steps or units are not necessarily limited to those clearly listed steps or units, but may include other steps or units that are not clearly listed or are inherent to these processes, methods, products or devices.

It should be understood that, when an element (such as a layer, a film, an area or a substrate) is described as being “on” another element, the element may be directly on the other element, or an intervening element may also be present. Moreover, in the specification and claims, when an element is described as being “connected” to another element, the element may be “directly connected” to the other element, or “connected” to the other element through a third element.

For ease of description, some nouns or terms involved in the embodiments of the present disclosure are described below:

TCON: timing controller.

As described in the background art, there is a technical problem that, in the actual system application of an electronic device, EMI generated by other chips other than a conventional wireless communication chip during operation and communication affect normal wireless communication functions. In order to solve the above problem, in an exemplary embodiment of the present disclosure, a method and apparatus for adjusting a harmonic parameter, a processor and an electronic device are provided.

According to the embodiments of the present disclosure, provided is a method for adjusting a harmonic parameter.

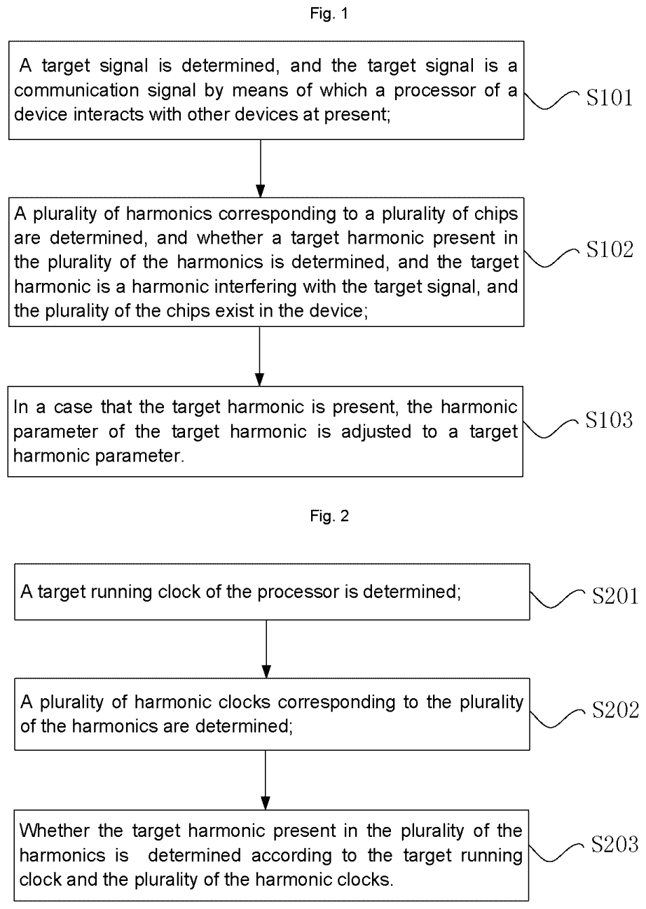

FIG. 1 is a flowchart of a method for adjusting a harmonic parameter provided according to an embodiment of the present disclosure. As shown in FIG. 1, the method includes the following steps:

Step S101: a target signal is determined, and the target signal is a communication signal by means of which a processor of a device interacts with other devices at present.

Step S102: a plurality of harmonics corresponding to a plurality of chips are determined, and whether a target harmonic present in the plurality of the harmonics is determined, and the target harmonic is a harmonic interfering with the target signal, and the plurality of the chips exist in the device.

Step S103: in a case that the target harmonic is present, the harmonic parameter of the target harmonic is adjusted to a target harmonic parameter.

Taking a notebook computer as an example, the notebook computer needs to support a plurality of frequency bands such as WiFi, LTE, 4G, 5G and Bluetooth, and may switch among the plurality of the frequency bands. A wireless communication antenna of the notebook computer is placed behind a display screen, so that normal use is easily affected by the EMI generated by the TCON.

Therefore, the present disclosure proposes the method for adjusting the harmonic parameter. By means of determining the wireless communication currently used by the device, the harmonics sent by other chips in the device are determined, and the harmonics generating interference with the communication signal currently used by the device are determined, and the parameters of the harmonics generating interference are adjusted, the harmonics generating interference are reduced, or the interference to the target signal is eliminated.

In an optional embodiment, the plurality of the harmonics corresponding to the plurality of the chips are determined, and whether the target harmonic present in the plurality of the harmonics is determined, includes: a plurality of harmonic frequency bands corresponding to the plurality of the harmonics are determined; a plurality of frequency band differences between the plurality of the harmonic frequency bands and a target frequency band are calculated respectively, and a plurality of frequency band difference absolute values corresponding to the plurality of the frequency band differences are determined, and the target frequency band is a communication frequency band corresponding to the target signal, one frequency band difference corresponds to one frequency band difference absolute value, and the frequency band difference absolute value is an absolute value of the frequency band difference; and whether the target harmonic present in the plurality of the harmonics is determined according to the plurality of the frequency band difference absolute values.

In an optional embodiment, whether the target harmonic present in the plurality of the harmonics is determined according to the plurality of the frequency band difference absolute values, includes: whether a target frequency band difference absolute value present in the plurality of the frequency band difference absolute values is determined, and the target frequency band difference absolute value is a frequency band difference absolute value within a preset frequency band range; and in a case that the target frequency band difference absolute value is present, the harmonic corresponding to the target frequency band difference absolute value is determined as the target harmonic.

As described above, the target frequency band corresponding to the target signal is determined, the frequency band difference absolute values between the frequency band corresponding to the harmonic generated by any one of a plurality of the other chips and the target frequency band are calculated, and which harmonics are harmonics interfering with the target signal are determined according to the frequency band difference absolute value.

In addition to the above method for determining the interference harmonics interfering with the target signal, the method further includes: according to a running clock of the target signal and clocks corresponding to the harmonics, determining which harmonics interfering with the target signal. The specific steps are as shown in FIG. 2, and include the following steps:

Step S201: a target running clock of the processor is determined;

step S202: a plurality of harmonic clocks corresponding to the plurality of the harmonics are determined, and one harmonic corresponds to one harmonic clock, and the harmonic clock is a clock of the corresponding harmonic; and

step S203: whether the target harmonic present in the plurality of the harmonics is determined according to the target running clock and the plurality of the harmonic clocks.

Further, the step specifically includes: whether a harmonic clock affecting the target running clock present in the plurality of the harmonic clocks is determined; and in a case that one or more harmonic clocks affecting the target running clock are present in the plurality of the harmonic clocks, the harmonic corresponding to the harmonic clock is determined as the target harmonic.

In the method provided in the present disclosure, after the target signal is determined, the method further includes: the target signal is broadcast to the plurality of the chips and the timing controller corresponding to the device. By means of the broadcast information, the other chips and the timing controller receive the communication signal, which is being used by the device and is sent by a CPU.

In an optional embodiment, in the case that the target harmonic is present, the harmonic parameter of the target harmonic is adjusted to the target harmonic parameter, includes: adjusting the clock of the target chip to a target clock, and under the target clock, the target harmonic does not affect the communication signal, and the target chip is a chip that emits the target harmonic; or, the spread spectrum of the target harmonic is adjusted to a target spread spectrum, and the target spread spectrum disperses energy corresponding to the target harmonic within a preset range; or, the clock of the target chip is adjusted to the target clock, and the spread spectrum of the target harmonic is adjusted to the target spread spectrum.

As described above, in the method of the present disclosure, by means of adjusting the running clock of the target harmonic, there is a relatively large difference between the running clock of the harmonic and the running clock of the target signal, so as to reduce the interference of the target harmonic on the communication signal; and on the other hand, the spread spectrum of the target harmonic may also be adjusted, and the energy of the target harmonic may be dispersed within one range by expanding the spread spectrum, thereby reducing the interference of the target harmonic on the target signal.

By means of the method for adjusting the harmonic parameter provided in the present disclosure, the problem of EMI is solved, and meanwhile, the method has the advantages of low cost, high flexibility and high expansibility. Moreover, a unified solution may be formed according to an algorithm, and the solution may be conveniently used in various projects.

It should be noted that, the steps shown in the flowchart of the drawings may be executed in a computer system, such as a group of computer-executable instructions, and, although a logical sequence is shown in the flowchart, in some cases, the shown or described steps may be executed in a different sequence than here.

The embodiments of the present disclosure further provide an apparatus for adjusting a harmonic parameter. It should be noted that, the apparatus for adjusting the harmonic parameter provided in the embodiments of the present disclosure may be used for executing the method for adjusting the harmonic parameter provided in the embodiments of the present disclosure. The apparatus for adjusting the harmonic parameter provided in the embodiments of the present disclosure will be introduced below.

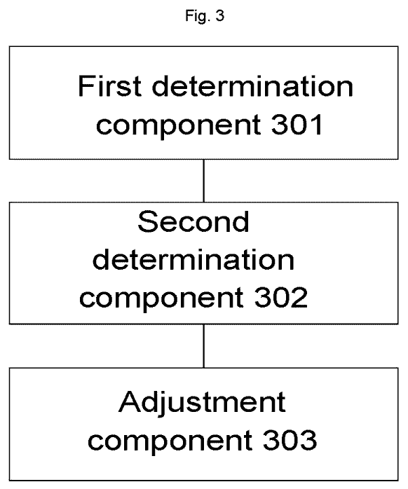

FIG. 3 is a schematic diagram of an apparatus for adjusting a harmonic parameter provided according to an embodiment of the present disclosure. As shown in FIG. 3, the apparatus includes:
a first determination component 301, configured to determine a target signal, and the target signal is a communication signal by means of which a processor of a device interacts with other devices at present;
a second determination component 302, configured to determine a plurality of harmonics corresponding to a plurality of chips, and determine whether a target harmonic is present in the plurality of the harmonics, and the target harmonic is a harmonic interfering with the target signal, and the plurality of the chips exist in the device; and
an adjustment component 303, configured to, in a case that the target harmonic is present, adjust the harmonic parameter of the target harmonic to a target harmonic parameter.

Optionally, the first determination component 301 includes: a first determination sub-component, configured to determine a plurality of harmonic frequency bands corresponding to the plurality of the harmonics; a second determination sub-component, configured to respectively calculate a plurality of frequency band differences between the plurality of the harmonic frequency bands and a target frequency band, and a plurality of frequency band difference absolute values corresponding to the plurality of the frequency band differences are determined, and the target frequency band is a communication frequency band corresponding to the target signal, one frequency band difference corresponds to one frequency band difference absolute value, and the frequency band difference absolute value is an absolute value of the frequency band difference; and a third determination sub-component, configured to determine whether the target harmonic is present in the plurality of the harmonics according to the plurality of the frequency band difference absolute values.

Optionally, the third determination sub-component includes: a first determination module, configured to determine whether a target frequency band difference absolute value is present in the plurality of the frequency band difference absolute values, and the target frequency band difference absolute value is a frequency band difference absolute value within a preset frequency band range; and a second determination module configured to, in a case that the target frequency band difference absolute value is present, the harmonic corresponding to the target frequency band difference absolute value is determined as the target harmonic.

Optionally, the first determination component 301 includes: a fourth determination sub-component, configured to determine a target running clock of the processor; a fifth determination sub-component, configured to determine a plurality of harmonic clocks corresponding to the plurality of the harmonics, and one harmonic corresponds to one harmonic clock, and the harmonic clock is a clock of the corresponding harmonic; and a sixth determination sub-component, configured to determine whether the target harmonic is present in the plurality of the harmonics according to the target running clock and the plurality of the harmonic clocks.

Optionally, the sixth determination sub-component, includes: a third determination module, configured to determine whether a harmonic clock affecting the target running clock is present in the plurality of the harmonic clocks; and a fourth determination module configured to, in a case that one or more harmonic clocks affecting the target running clock are present in the plurality of the harmonic clocks, the harmonic corresponding to the harmonic clock is determined as the target harmonic.

Optionally, the apparatus further includes: a control component configured to, after determining the target signal, the target signal is broadcast to the plurality of the chips and a timing controller corresponding to the device.

Optionally, the adjustment component 303 includes: a first adjustment sub-component, configured to adjust the clock of target chip to a target clock, and under the target clock, the target harmonic does not affect the communication signal, and the target chip is a chip that emits the target harmonic; or, a second adjustment sub-component, configured to adjust the spread spectrum of the target harmonic to a target spread spectrum, and the target spread spectrum disperses energy corresponding to the target harmonic within a preset range, or, adjust the clock of the target chip to the target clock, and adjust the spread spectrum of the target harmonic to the target spread spectrum.

The apparatus for adjusting the harmonic parameter includes a processor and a memory, and the first determination unit, the second determination unit, the adjustment unit and the like are all stored as program units in the memory, and the processor executes the program units stored in the memory, so as to implement corresponding functions.

The processor includes a kernel, and the kernel calls a corresponding program unit from the memory. One or more kernels may be provided, and kernel parameters are adjusted to solve the technical problem that in the actual system application of the electronic device, EMI generated by other chips other than a conventional wireless communication chip during operation and communication affect normal wireless communication functions.

The memory may include forms at least one of the following: a volatile memory, a random access memory (RAM), a nonvolatile memory in a computer-readable medium, such as a read-only memory (ROM) or a flash memory (flash RAM), and the memory includes one or more storage chips.

The embodiments of the present disclosure provide a computer-readable storage medium, on which a program is stored, and when executed by a processor, the program implements a method for adjusting a harmonic parameter.

The embodiments of the present disclosure provide a processor, and the processor is configured to run a program, and the program executes a method for adjusting a harmonic parameter when running.

The embodiments of the present disclosure provide a device, the device includes a processor, a memory, and a program, which is stored on the memory and is executable on the processor, and the processor implements at least the following steps when executing the program: a target signal is determined, and the target signal is a communication signal by means of which a processor of a device interacts with other devices at present; a plurality of harmonics corresponding to a plurality of chips are determined, and whether a target harmonic present in the plurality of the harmonics is determined, and the target harmonic is a harmonic interfering with the target signal, and the plurality of the chips exist in the device; and in a case that the target harmonic is present, the harmonic parameter of the target harmonic is adjusted to a target harmonic parameter.

Optionally, the plurality of the harmonics corresponding to the plurality of the chips are determined, and whether the target harmonic present in the plurality of the harmonics is determined, includes: a plurality of harmonic frequency bands corresponding to the plurality of the harmonics are determined; a plurality of frequency band differences between the plurality of the harmonic frequency bands and a target frequency band are calculated respectively, and a plurality of frequency band difference absolute values corresponding to the plurality of the frequency band differences are determined, and the target frequency band is a communication frequency band corresponding to the target signal, one frequency band difference corresponds to one frequency band difference absolute value, and the frequency band difference absolute value is an absolute value of the frequency band difference; and whether the target harmonic present in the plurality of the harmonics is determined according to the plurality of the frequency band difference absolute values.

Optionally, whether the target harmonic is present in the plurality of the harmonics is determined according to the plurality of the frequency band difference absolute values, includes: whether a target frequency band difference absolute value present in the plurality of the frequency band difference absolute values is determined, and the target frequency band difference absolute value is a frequency band difference absolute value within a preset frequency band range; and in a case that the target frequency band difference absolute value is present, the harmonic corresponding to the target frequency band difference absolute value is determined as the target harmonic.

Optionally, the plurality of the harmonics corresponding to the plurality of the chips are determined, and whether the target harmonic present in the plurality of the harmonics is determined, includes: a target running clock of the processor is determined; a plurality of harmonic clocks corresponding to the plurality of the harmonics are determined, and one harmonic corresponds to one harmonic clock, and the harmonic clock is a clock of the corresponding harmonic; and whether the target harmonic present in the plurality of the harmonics is determined according to the target running clock and the plurality of the harmonic clocks.

Optionally, whether the target harmonic is present in the plurality of the harmonics is determined according to the target running clock and the plurality of the harmonic clocks, includes: whether a harmonic clock affecting the target running clock present in the plurality of the harmonic clocks is determined; and in a case that one or more harmonic clocks affecting the target running clock are present in the plurality of the harmonic clocks, the harmonic corresponding to the harmonic clock is determined as the target harmonic.

Optionally, after the target signal is determined, the method further includes: the target signal is broadcast to the plurality of the chips and a timing controller corresponding to the device.

Optionally, in the case that the target harmonic is present, the harmonic parameter of the target harmonic is adjusted to the target harmonic parameter, includes: the clock of the target chip is adjusted to a target clock, and under the target clock, the target harmonic does not affect the communication signal, and the target chip is a chip that emits the target harmonic; or, the spread spectrum of the target harmonic is adjusted to a target spread spectrum, and the target spread spectrum disperses energy corresponding to the target harmonic within a preset range; or, the clock of the target chip is adjusted to the target clock, and the spread spectrum of the target harmonic is adjusted to the target spread spectrum.

The device herein may be a server, a PC, a PAD, a mobile phone, or the like.

The present disclosure further provides a computer program product, which is adapted to, when being executed on a data processing device, initializing a program at least having the following method steps: a target signal is determined, and the target signal is a communication signal by means of which a processor of a device interacts with other devices at present; a plurality of harmonics corresponding to a plurality of chips are determined, and whether a target harmonic present in the plurality of the harmonics is determined, and the target harmonic is a harmonic interfering with the target signal, and the plurality of the chips exist in the device; and in a case that the target harmonic is present, the harmonic parameter of the target harmonic is adjusted to a target harmonic parameter.

Optionally, the plurality of the harmonics corresponding to the plurality of the chips are determined, and whether the target harmonic present in the plurality of the harmonics is determined, includes: a plurality of harmonic frequency bands corresponding to the plurality of the harmonics are determined; a plurality of frequency band differences between the plurality of the harmonic frequency bands and a target frequency band are calculated respectively, and a plurality of frequency band difference absolute values corresponding to the plurality of the frequency band differences are determined, and the target frequency band is a communication frequency band corresponding to the target signal, one frequency band difference corresponds to one frequency band difference absolute value, and the frequency band difference absolute value is an absolute value of the frequency band difference; and whether the target harmonic present in the plurality of the harmonics is determined according to the plurality of the frequency band difference absolute values.

Optionally, whether the target harmonic present in the plurality of the harmonics is determined according to the plurality of the frequency band difference absolute values, includes: whether a target frequency band difference absolute value present in the plurality of the frequency band difference absolute values is determined, and the target frequency band difference absolute value is a frequency band difference absolute value within a preset frequency band range; and in a case that the target frequency band difference absolute value is present, the harmonic corresponding to the target frequency band difference absolute value is determined as the target harmonic.

Optionally, the plurality of the harmonics corresponding to the plurality of the chips are determined, and whether the target harmonic present in the plurality of the harmonics is determined, includes: a target running clock of the processor is determined; a plurality of harmonic clocks corresponding to the plurality of the harmonics are determined, and one harmonic corresponds to one harmonic clock, and the harmonic clock is a clock of the corresponding harmonic; and whether the target harmonic present in the plurality of the harmonics is determined according to the target running clock and the plurality of the harmonic clocks.

Optionally, whether the target harmonic present in the plurality of the harmonics is determined according to the target running clock and the plurality of the harmonic clocks, includes: whether a harmonic clock affecting the target running clock present in the plurality of the harmonic clocks is determined; and in a case that one or more harmonic clocks affecting the target running clock are present in the plurality of the harmonic clocks, the harmonic corresponding to the harmonic clock is determined as the target harmonic.

Optionally, after the target signal is determined, the method further includes: the target signal is broadcast to the plurality of the chips and a timing controller corresponding to the device.

Optionally, in the case that the target harmonic is present, the harmonic parameter of the target harmonic is adjusted to the target harmonic parameter, includes: the clock of the target chip is adjusted to a target clock, and under the target clock, the target harmonic does not affect the communication signal, and the target chip is a chip that emits the target harmonic; or, the spread spectrum of the target harmonic is adjusted to a target spread spectrum, and the target spread spectrum disperses energy corresponding to the target harmonic within a preset range; or, the clock of the target chip is adjusted to the target clock, and the spread spectrum of the target harmonic is adjusted to the target spread spectrum.

In the above embodiments of the present disclosure, the description of each embodiment has its own emphasis. For parts that are not described in detail in a certain embodiment, reference may be made to related descriptions of other embodiments.

In the several embodiments provided by the present disclosure, it should be understood that, the disclosed technical content may be implemented in other manners. The apparatus embodiments described above are merely exemplary, for example, the division of the units may be a logic function division, there may be other division manners in practical implementation, for example, a plurality of units or components may be combined or integrated to another system, or some features may be omitted or not implemented. From another point of view, the displayed or discussed mutual coupling or direct coupling or communication connection may be indirect coupling or communication connection of units or modules through some interfaces, and may be in electrical or other forms.

The units described as separate components may be separated physically or not, components displayed as units may be physical units or not, namely, may be located in one place, and may also be distributed on a plurality of units. A part or all units may be selected to implement the purposes of the solutions in the present embodiment according to actual demands.

In addition, the functional units in various embodiments of the present disclosure may be integrated in one processing unit, or the units individually exist physically, or two or more units are integrated in one unit. The integrated unit may be implemented in the form of hardware, and may also be implemented in the form of a software functional unit.

In a case that the integrated unit is implemented in the form of the software functional unit and is sold or used as an independent product, it may be stored in a computer-readable storage medium. Based on this understanding, the technical solutions of the present disclosure substantially, or the part contributing to the prior art, or a part or all the technical solutions may be implemented in the form of a software product, the computer software product is stored in a storage medium, which includes several instructions for enabling a computer device (which may be a personnel computer, a server, or a network device or the like) to execute all or part of the steps of the method in various embodiments of the present disclosure. The foregoing storage medium includes a variety of media capable of storing program codes, such as a USB disk, a read-only memory (ROM, Read-Only Memory), a random access memory (RAM, Random Access Memory), a mobile hard disk, a magnetic disk, or an optical disk.

From the above description, it can be seen that the above embodiments of the present disclosure achieve the following technical effects:
1) By means of the method provided in the present disclosure, the problem of EMI is solved, and the method has the advantages of low cost, high flexibility and high expansibility.
2) By means of the method provided in the present disclosure, a unified solution may be formed according to the algorithm, and the solution may be conveniently used in various projects.

The foregoing descriptions are only some embodiments of the present disclosure, and are not intended to limit the present disclosure. For those skilled in the art, the present disclosure may have various changes and modifications. Any modifications, equivalent replacements, improvements and the like, made within the spirit and principles of the present disclosure, shall fall within the protection scope of the present disclosure.

1. A method for adjusting a harmonic parameter, wherein the method comprises:
determining a target signal, wherein the target signal is a communication signal by means of which a processor of a device interacts with other devices at present;
determining a plurality of harmonics corresponding to a plurality of chips, and determining whether a target harmonic is present in the plurality of the harmonics, wherein the target harmonic is a harmonic interfering with the target signal, and the plurality of the chips exist in the device; and
in a case that the target harmonic is present, adjusting the harmonic parameter of the target harmonic to a target harmonic parameter.

2. The method according to claim 1, wherein determining the plurality of the harmonics corresponding to the plurality of the chips, and determining whether the target harmonic is present in the plurality of the harmonics, comprises:
determining a plurality of harmonic frequency bands corresponding to the plurality of the harmonics;
respectively calculating a plurality of frequency band differences between the plurality of the harmonic frequency bands and a target frequency band, and determining a plurality of frequency band difference absolute values corresponding to the plurality of the frequency band differences, wherein the target frequency band is a communication frequency band corresponding to the target signal, one frequency band difference corresponds to one frequency band difference absolute value, and the frequency band difference absolute value is an absolute value of the frequency band difference; and
determining whether the target harmonic is present in the plurality of the harmonics according to the plurality of the frequency band difference absolute values.

3. The method according to claim 2, wherein determining whether the target harmonic is present in the plurality of the harmonics according to the plurality of the frequency band difference absolute values, comprises:
determining whether a target frequency band difference absolute value is present in the plurality of the frequency band difference absolute values, wherein the target frequency band difference absolute value is a frequency band difference absolute value within a preset frequency band range; and
in a case that the target frequency band difference absolute value is present, determining, to be the target harmonic, the harmonic corresponding to the target frequency band difference absolute value.

4. The method according to claim 1, wherein determining the plurality of the harmonics corresponding to the plurality of the chips, and determining whether the target harmonic is present in the plurality of the harmonics, comprises:
determining a target running clock of the processor;
determining a plurality of harmonic clocks corresponding to the plurality of the harmonics, wherein one harmonic corresponds to one harmonic clock, and the harmonic clock is a clock of the corresponding harmonic; and
determining whether the target harmonic is present in the plurality of the harmonics according to the target running clock and the plurality of the harmonic clocks.

5. The method according to claim 4, wherein determining whether the target harmonic is present in the plurality of the harmonics according to the target running clock and the plurality of the harmonic clocks, comprises:
determining whether a harmonic clock affecting the target running clock is present in the plurality of the harmonic clocks; and
in a case that one or more the harmonic clocks affecting the target running clock are present in the plurality of the harmonic clocks, determining, to be the target harmonic, the harmonic corresponding to the harmonic clock.

6. The method according to claim 1, wherein after determining the target signal, the method further comprises:
broadcasting the target signal to the plurality of the chips and a timing controller corresponding to the device.

7. The method according to claim 1, wherein in the case that the target harmonic is present, adjusting the harmonic parameter of the target harmonic to the target harmonic parameter, comprises:
adjusting the clock of target chip to a target clock, wherein under the target clock, the target harmonic does not affect the communication signal, and the target chip is a chip that emits the target harmonic;
or,
adjusting the spread spectrum of the target harmonic to a target spread spectrum, wherein the target spread spectrum disperses energy corresponding to the target harmonic within a preset range;
or,
adjusting the clock of the target chip to the target clock, and adjusting the spread spectrum of the target harmonic to the target spread spectrum.

8. An apparatus for adjusting a harmonic parameter, wherein the apparatus comprises:
a first determination component, configured to determine a target signal, wherein the target signal is a communication signal by means of which a processor of a device interacts with other devices at present;
a second determination component, configured to determine a plurality of harmonics corresponding to a plurality of chips, and determine whether a target harmonic is present in the plurality of the harmonics, wherein the target harmonic is a harmonic interfering with the target signal, and the plurality of the chips exist in the device; and
an adjustment component, configured to, in a case that the target harmonic is present, adjust the harmonic parameter of the target harmonic to a target harmonic parameter.

9. A computer-readable storage medium, wherein the computer-readable storage medium comprises a stored program, and the program execute a method for adjusting a harmonic parameter, the method for adjusting the harmonic parameter comprises:
determining a target signal, wherein the target signal is a communication signal by means of which a processor of a device interacts with other devices at present;
determining a plurality of harmonics corresponding to a plurality of chips, and determining whether a target harmonic is present in the plurality of the harmonics, wherein the target harmonic is a harmonic interfering with the target signal, and the plurality of the chips exist in the device; and
in a case that the target harmonic is present, adjusting the harmonic parameter of the target harmonic to a target harmonic parameter.

10. A processor, wherein the processor is configured to run a program, and the program executes the method for adjusting the harmonic parameter according to claim 1 while running.

11. An electronic device, comprising: one or more processors, a memory, and one or more programs, wherein the one or more programs are stored in the memory and are configured to be executed by the one or more processors, and the one or more programs are configured to execute the method for adjusting the harmonic parameter according to claim 1.

12. The apparatus according to claim 8, wherein the first determination component comprises:
a first determination sub-component, configured to determine a plurality of harmonic frequency bands corresponding to the plurality of the harmonics;
a second determination sub-component, configured to respectively calculate a plurality of frequency band differences between the plurality of the harmonic frequency bands and a target frequency band, and determine a plurality of frequency band difference absolute values corresponding to the plurality of the frequency band differences, wherein the target frequency band is a communication frequency band corresponding to the target signal, one frequency band difference corresponds to one frequency band difference absolute value, and the frequency band difference absolute value is an absolute value of the frequency band difference; and
a third determination sub-component, configured to determine whether the target harmonic is present in the plurality of the harmonics according to the plurality of the frequency band difference absolute values.

13. The apparatus according to claim 12, where the third determination sub-component comprises:
a first determination module, configured to determine whether a target frequency band difference absolute value is present in the plurality of the frequency band difference absolute values, wherein the target frequency band difference absolute value is a frequency band difference absolute value within a preset frequency band range; and
a second determination module, configured to, in a case that the target frequency band difference absolute value is present, determining, to be the target harmonic, the harmonic corresponding to the target frequency band difference absolute value.

14. The apparatus according to claim 8, wherein the first determination component comprises:
a fourth determination sub-component, configured to determine a target running clock of the processor;
a fifth determination sub-component, configured to determine a plurality of harmonic clocks corresponding to the plurality of the harmonics, wherein one harmonic corresponds to one harmonic clock, and the harmonic clock is a clock of the corresponding harmonic; and
a sixth determination sub-component, configured to determine whether the target harmonic is present in the plurality of the harmonics according to the target running clock and the plurality of the harmonic clocks.

15. The apparatus according to claim 14, wherein, the sixth determination sub-component, comprises:
a third determination module, configured to determine whether a harmonic clock affecting the target running clock is present in the plurality of the harmonic clocks; and
a fourth determination module, configured to, in a case that one or more harmonic clocks affecting the target running clock are present in the plurality of the harmonic clocks, determining, to be the target harmonic, the harmonic corresponding to the harmonic clock.

16. The apparatus according to claim 8, wherein, the apparatus further comprises:
a control component, configured to after determining the target signal, broadcasting the target signal to the plurality of the chips and a timing controller corresponding to the device.

17. The apparatus according to claim 8, wherein, the adjustment component comprises:
a first adjustment sub-component, configured to adjust the clock of target chip to a target clock, wherein under the target clock, the target harmonic does not affect the communication signal, and the target chip is a chip that emits the target harmonic;
or,
a second adjustment sub-component, configured to adjust the spread spectrum of the target harmonic to a target spread spectrum, wherein the target spread spectrum disperses energy corresponding to the target harmonic within a preset range, or, adjust the clock of the target chip to the target clock, and adjust the spread spectrum of the target harmonic to the target spread spectrum.

18. The computer-readable storage medium according to claim 9, wherein determining the plurality of the harmonics corresponding to the plurality of the chips, and determining whether the target harmonic is present in the plurality of the harmonics, comprises:
determining a plurality of harmonic frequency bands corresponding to the plurality of the harmonics;
respectively calculating a plurality of frequency band differences between the plurality of the harmonic frequency bands and a target frequency band, and determining a plurality of frequency band difference absolute values corresponding to the plurality of the frequency band differences, wherein the target frequency band is a communication frequency band corresponding to the target signal, one frequency band difference corresponds to one frequency band difference absolute value, and the frequency band difference absolute value is an absolute value of the frequency band difference; and
determining whether the target harmonic is present in the plurality of the harmonics according to the plurality of the frequency band difference absolute values.

19. The computer-readable storage medium according to claim 18, wherein determining whether the target harmonic is present in the plurality of the harmonics according to the plurality of the frequency band difference absolute values, comprises:
determining whether a target frequency band difference absolute value is present in the plurality of the frequency band difference absolute values, wherein the target frequency band difference absolute value is a frequency band difference absolute value within a preset frequency band range; and
in a case that the target frequency band difference absolute value is present, determining, to be the target harmonic, the harmonic corresponding to the target frequency band difference absolute value.

20. The computer-readable storage medium according to claim 9, wherein determining the plurality of the harmonics corresponding to the plurality of the chips, and determining whether the target harmonic is present in the plurality of the harmonics, comprises:
determining a target running clock of the processor;
determining a plurality of harmonic clocks corresponding to the plurality of the harmonics, wherein one harmonic corresponds to one harmonic clock, and the harmonic clock is a clock of the corresponding harmonic; and
determining whether the target harmonic is present in the plurality of the harmonics according to the target running clock and the plurality of the harmonic clocks.
